(19) United States
(12) Patent Application Publication
(10) Pub. No.: US 2005/0230347 A1
(43) Pub. Date: Oct. 20, 2005

(54) Methods for tinting plastic films and sheets with melanin

(76) Inventors: James Martin Gallas, San Antonio, TX (US); Mark Penick, San Antonio, TX (US); Melvin Eisner, Houston, TX (US); Joshua James, San Antonio, TX (US)

Correspondence Address: James M. Gallas, Suite 101, 16120 College Oak, San Antonio, TX, 78249, US

(21) Appl. No.: 10/823,848

(22) Filed: Apr. 14, 2004

(51) Int. Cl. B44C 1/22; B31D 3/00

(52) U.S. Cl. 216/56; 216/83

(57) ABSTRACT

This invention relates to the field of eye protection and vision enhancement by filters of UV and the higher energy visible (HEV) light—such as sunglass lenses. More specifically, it relates to the process of tinting plastic films and sheets with solutions of synthetic melanin. Such plastic films may include sunglass lenses, and ophthalmic lenses in general, windows, light filters such as photograph covers, canopies, etc., and other similar media utilized to protect valuable goods from radiation damage.

### CROSS-REFERENCE TO RELATED APPLICATIONS

none

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to the field of eye protection and vision enhancement by filters of UV and the higher energy visible (HEV) light—such as sunglass lenses. More specifically, it relates to the process of tinting plastic films and sheets with solutions of synthetic melanin. Such plastic films may include sunglass lenses, and ophthalmic lenses in general, windows, light filters such as photograph covers, canopies, etc., and other similar media utilized to protect valuable goods from radiation damage.

### BRIEF SUMMARY OF THE INVENTION

Previous art has taught the value of optical plastic media, such as sunglasses and visors, that contain melanin, for the purpose of filtering UV and high energy visible (HEV) light (Gallas U.S. Pat. No. 5,112,883 for example) from sunlight and artificial light. These patents are incorporated herein in their entirety

Over the last decade, increased scientific research has demonstrated the threat from UV light to the ocular lens, and HEV (high energy visible) light to the retina. In addition to the preservation of the health and the ocular lens, filters that reduce or eliminate HEV (mainly the blue and violet) light generally impart an increased contrast and visual acuity to the wearer of such filters. However, lenses that reduce HEV light often tend to cause a loss of proper color perception.

Melanin light filters provide the benefit of reducing HEV light without distorting the perception of color. Many of the sunglass lenses made today are made by inserting a clear plastic lens into a solution containing the dye that ultimately imparts the final color to the lens. Tinting occurs by the process of diffusion whereby the dye molecules in the dye solution penetrate into the plastic surface. In the common practice of the art today, the dye is typically dispersed in water and the water-dye-bath system is heated close to the boiling temperature of water so as to increase the rate of diffusion. In this manner, a suitable concentration of the dye occurs on the surface of the immersed plastic lens, resulting in an adequate level of coloration. When the lens is extracted from the dye bath and allowed to dry the dye is then trapped within the plastic surface.

Not all dye bath systems result in adequate tinting. Some dye molecules are too large to penetrate the surface structure of the plastic, submerged into the dye-solvent, liquid in question; and many dyes encounter a strong hydrophobic barrier that occurs between the plastic article to be tinted and the aqueous medium that is typically used in most tinting baths to support the dye. A common, but always effective way to reduce the hydrophobic barrier is to co-dissolve surfactants with the aqueous-dye system.

A second mitigating factor for the tinting process to occur is the limited size of the inter-polymeric spacings and cross-linking networks or pores that comprise the molecular surface of the plastic facing the dyes as they diffuse from the solvent system inward toward the plastic surface. Typically, these dye molecules penetrate several microns into the plastic surface.

Recent research suggests that melanin is a covalently-bonded polymer of quinone and hydroquinone type moieties that may also contain carboxyl and amine side groups and that form nanometer-sized sheets. These covalently-bonded polymers can aggregate to form micron-sized particles.

Thus, melanin and other multi-nanometer-sized polymers may fail to tint plastic surfaces because: 1) these polymers are too large to penetrate the sub-nanometer microstructure of the plastic surface and 2) hydrophilic polymers such as melanin dispersed in water may tend to remain solvated or hydrogen-bonded with the water phase and resist passage across the hydrophobic barrier and diffusion into the submerged plastic at the water-plastic interface.

Accordingly, the essential feature of this idea of this invention is to:
A.
   1) etch the surface of the plastic film or sheet that is to be tinted—so as to increase the “pore” sizes or passageway sizes of the surface structure of the plastic film or sheet; and by
   2) functionalizing the plastic surface so as to cause it to become hydrophilic and thus facilitate the penetration of hydrophilic dye molecule into the plastic surface.
and,
B. To accomplish A. without causing haze or light scatter by ensuring that the etching of A. 1) or the functionalization of A. 2) create voids or pore sizes that remain less than approximately 100 nm—a size regime that ensures minimal scatter of visible light.

### ADVANTAGES OF THE INVENTION

1. The invention allows the tinting process to occur for many new and desirable molecules that previously could not be used in tinting because they were too large and/or because they were too hydrophilic

2. The invention allows a uniform coloration to be realized in prescription sun lenses where the thickness of the finished prescription lens will have variations, and thus varying darkness, depending upon the specific prescription;

3. No dye will be wasted during the surfacing process where much of the plastic is removed and would take away a corresponding proportion of the dye if it were dispersed throughout the lens, rather than all of it being on the surface of the lens as in the current invention.

### BRIEF DESCRIPTION OF THE SEVERAL VIEWS OF THE DRAWING

For a detailed description of the present invention, reference will now be made to the accompanying drawings wherein:

FIG. 1 is a diagram illustrating the pores and passageways and their average sizes at the surface of the plastic to be tinted.

FIG. 2 is a transmission spectrum of melanin.

FIG. 3 is a transmission spectrum of a CR39 lens before and after treatment with a solution of melanin according to Procedure 6.

### DETAILED DESCRIPTION OF THE INVENTION

### SUMMARY OF DEFINITIONS

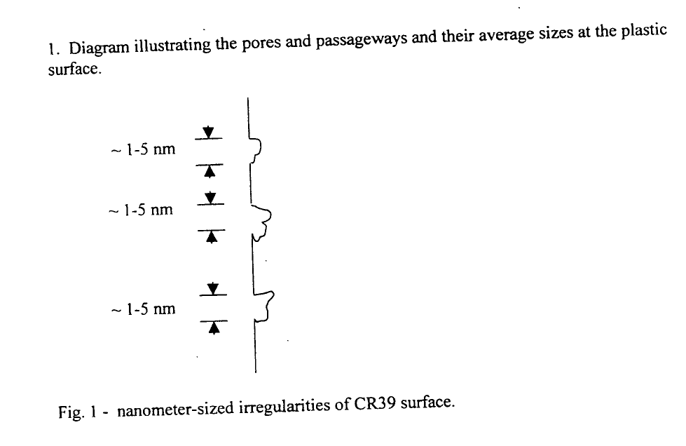

“Etching.” Creating, generally by a chemical process, microscopic holes or pits on the surface of a flat piece of material. In this invention, such a material is plastic or glass and the average size of the holes or pits is intended to be nominally less than 100 nm or a size that results in minimal light scatter or observable haze. This is further illustrated in FIG. 1.

“Functionalization.” To chemically react with a molecule or surface so as to create a new molecular or surface structure with new chemical properties. In the present case, functionalization is mainly performed on the surface of the CR39 plastic with the general goal of converting the CR39 molecular surface from a hydrophobic character to a hydrophilic character.

“CR39.” Trademark pf PPG Industries for a diethyleneglycol bis-allylcarbonate, a resin that cures to form a cross-linked plastic widely used in ophthalmic lenses.

“Plastic Film”. A thin, flat piece of plastic, nominally of thickness measured in mils, or thousandths of an inch, typically 1 to 20, and flexible.

“Plastic Sheet”. A thicker, nominally of thickness greater than 20 mils and typically inflexible.

“Tinting Process.” A process in which a plastic sheet or lens or film surface is submerged in a dye bath and colored through a diffusion process where the dye molecule leaves the liquid phase at the liquid/solid plastic media interface and enters the microstructure of the plastic medium. The tinting is usually carried out under heat and sometimes under pressure, or under both heat and pressure, to increase the diffusion rates.

“Tinted Plastic Film or Sheet.” A film or sheet of plastic that is colored by a tinting process.

“Large Molecule.” A molecule or polymer that is 1 to several nanometers in size or that is generally larger than the typical dye molecules that are currently used to tint plastic surfaces. These typical dyes are nominally less than 1 nanometer in size.

“Polymer Hard Coating.” A clear plastic resin that has incorporated various cross-linking agents that results in a hard, scratch resistant coating of approximately 5 to 10 microns in thickness when commonly used to cover the surface of plastic lenses such as one made using CR39.

### Preferred Embodiment

This is a method for tinting a lens with a large molecule, such as melanin, through the process of diffusion in which steps are taken to increase the rates of diffusion. Normally such steps involve heating; however this is limited in practice by the boiling temperature of water, which is the solvent of choice by the industry. And nominally, the temperature selected is very close to boiling. Another step usually taken to increase the rate of diffusion is the use of surfactants to reduce the hydrophobic barrier.

In the current application, the diffusion rates are increased by enlarging the pores or microscopic crevices of the plastic surface by chemically etching the surface. Generally, etching causes surface irregularities or holes or pits that cause haze and therefore make such a surface unacceptable for optical or ophthalmic applications. Applicant has found, however, that etching can be done up to the point prior to causing haze, but where diffusion rates have increased thereby increasing the tinting rate.

According to the present invention CR 39 is used as the plastic to be etched; however this technique is not limited to CR 39, and other plastic surfaces, or even glass may be etched to increase the pore sizes at levels that do not cause haze.

Applicant has also found that the tinting rate can be further increased by functionalizing the surface of the plastic so that the new surface structures become hydrophilic and allow chemical bonding to occur between the melanin or dye molecular surface groups. This has the effect of increasing the overall effective diffusion of the molecules into the surface of the plastic that is to be tinted—by reducing the rate outward back into the dye/solvent system.

Applicant has found that, for melanin, it is also possible to increase the diffusion rates into the plastic surface by decreasing the size of the melanin particles by either bleaching the melanin or by choosing synthesis conditions to favor small particles. Bleaching is known to reduce the particle sizes of melanin (“Structural Studies of Bleached Melanin by Synchrotron Small-angle X-ray Scattering,” Kenneth C. Littrell, James M. Gallas, Gerry W. Zajac, Pappannan Thiyagarajan (2003), Photochemistry Photobiology. Vol. 77, Issue. 2, p. 115.). Increasing the molar concentrations of the oxidizers used during melanin polymerization or synthesis will also lead to smaller molecular weight and size of the melanin particles produced.

Various melanin precursors may also be used to make the melanins used for tinting as described in the Gallas patents previously cited.

While the methods described here for improving the tinting of plastics is found to be beneficial for tinting with melanin, the same process can be used to tint plastics with large molecular weight dyes and which may also be hydrophilic.

CR-39 Tinting with Melanin

1) Etching Step:

CR-39 can be efficiently etched with an etching bath consisting of hot aqueous 1M NaOH solution, to which is added some tetrabutylammonium salt as a phase-transfer catalyst. The lens is treated with this for a period of not more than 1.5 hours (at which time the surface begins to become wavy). It is expected that other quaternary ammonium salts, such as domiphen bromide, could also serve the same purpose as the tetrabutylammonium bromide. Side-by-side experiments were done without the tetrabutylammonium bromide but with 7M NaOH solution. These demonstrate that the phase-transfer activity of the tetrabutylammonium bromide gives a superior etching bath, more than compensating for a lower NaOH concentration. In fact, results obtained with 7M NaOH alone were never comparable to the etching done by 1M NaOH plus tetrabutylammonium bromide.

The purpose of the etching bath is to prepare for tinting. The effectiveness of the etching bath in this regard can be further improved by addition of a small amount of hexanediamine. This is believed to link itself with the polymer by reacting with the carbonate groups in the CR-39. This is expected to give the structure: —CH2-O—CONH—(CH2)6-NH2. Upon being placed in the melanin tinting bath (see below) this should react with the o-quinone moieties in the melanin to give an amino-catechol moiety (which would be swiftly oxidized by air to a strongly colored aminoquinone). Thus the melanin becomes covalently linked to the polymer. L-lysine (as purchased from the local grocery store) can also be used in place of hexanediamine, although the hexanediamine seems to be more effective at enhancing tinting than L-lysine is. (It is likely that the steric hindrance provided by the lysine's COOH group makes it more difficult for the neighboring amine group to react with melanin.)

The treated lens can be tinted by a bath containing glycerine, water, acetic acid and melanin, heated to between 80 and 120 degrees C. Glycerine is the main solvent; the others are added only in small quantities. After approximately one hour the lens is withdrawn from the bath and rinsed twice with water. (A trace of NaOH in the first rinse is helpful to remove melanin clinging to, but not actually adsorbed into, the lens surface.) The lens will be seen at this point to be tinted with melanin. This tint does not wash off in water, nor can it be wiped off with a paper towel wet with isopropanol.

The melanin referred to above was produced by oxidizing catechol with bleach and a catalytic amount of Cu(NH3)4++, followed by acidification and filtration. This procedure is known to produce melanin with an unusually small percentage of COOH groups, relative to other methods of oxidation, and with no OSO3- groups. Thus it is more likely the melanin will be a neutral molecule rather than an anion. This is important because the CR-39 is not nearly as polar as water and therefore greatly prefers to absorb neutral molecules.

Examples of etching CR-39 and tinting with melanin or a melanin precursor.

Baths:

The following baths are used in the Procedures:
Bath 1. 0.014 M domiphen bromide and 1.6 M NaOH in distilled water.
Bath 2. 0.014 M domiphen bromide, 0.05 M 1,6-hexanediamine, and 1 M NaOH in Distilled water.
Bath 3. 0.25 M domiphen bromide and 1 M NaOH in distilled water.
Bath 4. 0.2 M 1,6-hexanediamine in distilled water.
Bath 5. 1.4 g of melanin dissolved in 65 mL of water with 1.5 mL 25% NaOH added.
Bath 6. A molten mixture of 53% (by weight) of catechol, 43% water and 4% acetic acid (At room temp this is a solid.)—at 160-180 degrees F.
Bath 7. 0.14 M dodecylbenzenesulfonic acid and 0.81 M sulfuric acid in distilled water. Add to 54 mL of this a solution of 1.07 g of melanin in 20 mL distilled water+12 drops 25% NaOH.

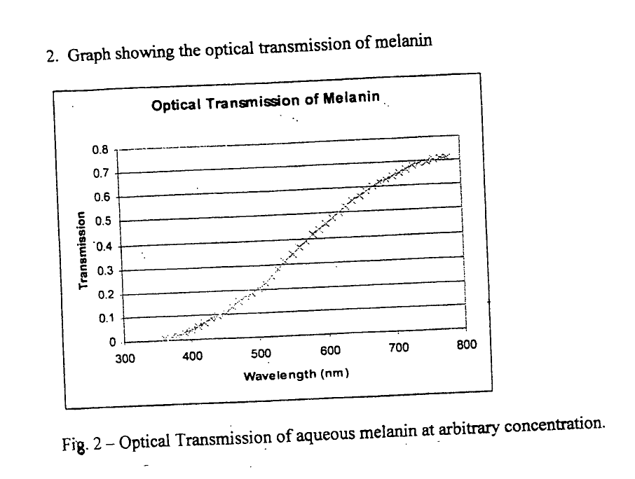

The melanin-mentioned above was produced by oxidation of catechol, in the presence of one equivalent of NaOH and a catalytic amount of copper, with 3.3 equivalents of bleach, followed by acidifying the mixture, gravity filtration and air drying. A transmission spectrum of the melanin thus formed is shown in FIG. 2

Other melanin precursors may be used such as L-dopa, dopamine, 5,6-dihydroxyindole, etc.

Procedure 1.

Etch CR-39 lens in bath 2 for 1 hour at 70-90 degrees C. Then remove the lens, let cool. rinse 2× in distilled water, and place it in bath 5 at 80-90 degrees C. While the lens is in bath 5 slowly add [ 1/10 of the bath volume] of ethylene glycol diacetate with stirring over the next half hour. Remove lens, let cool, rinse 2× with distilled water and wipe dry

Procedure 2.

Etch CR-39 in bath I for one hour at 70-90 degrees C., followed (after letting it cool and rinsing 2× in distilled water) by bath 4 for ½ hour at 70-90 degrees C., followed (after letting it cool and rinsing 2× in distilled water) by bath 5 at 80-90 degrees C. While the lens is in bath S slowly add [ 1/10 of the bath volume] of ethylene glycol diacetate with stirring over the next half hour. Remove lens, let cool, rinse 2× with distilled water and wipe dry.

Procedure 3.

Etch CR-39 in bath 3 for ¾ hour at 70-90 degrees C., followed (after letting it cool and rinsing 2× in distilled water) by bath 4 for ½ hour at 70-90 degrees C., followed (after letting it cool and rinsing 2× in distilled water) by bath 6 at 70-90 degrees C. for ½ hour. Remove from bath 6. after letting it cool and rinsing 2× in distilled water, dip it in bath 3. Remove from bath 3, do not rinse, and heat lens in air to over 100 degrees C. for one hour. Let cool and scrub it clean with distilled water and with 91% isopropanol/9% water.

Procedure 4.

Heat lens in bath 7 for one hour at 70-90˜C. Remove lens, let it cool, rinse it off 2× in distilled water, and wipe dry.

Etch ('R-39 lens in bath 2 for 1 hour at 70-90 degrees C. Then remove the lens, let cool, 2× in distilled water, and place it in bath 6 at 70-90 degrees C. for ½ hour. Remove from bath 6, after letting it cool and rinsing 2× in distilled water, dip it in bath 3. Remove from bath 3 and heat lens in air to over 100 degrees C. for one hour. Let cool and scrub it clean with distilled water and with 91% isopropanol/9% water.

All˜the articles tinted according to procedures 1-6 were lightly colored with melanin.

Procedure 6.

This is a four-step procedure in which the plastic is etched, functionalized, then tinted in a bath containing a melanin precursor and then exposed to an agent causing polymerization of the precursor to form melanin on the surface of the plastic.
Step 1 A piece of CR39 plastic Was etched in a bath consisting of 0.25M domiphen-bromide and 1 M NaOH at 170-180 degrees F. for one hour. It was removed, and cooled for a few seconds in the an air stream, and wash twice in distilled water.
Step 2. The above piece of CR-39 was submerged in an 0.2 M aqueous 1,6-hexanediamine batt˜ at 165-180 degrees F., for 35 minutes removed, and cooled for a few seconds in an air stream, and washed twice in distilled water.
Step 3. The above piece of CR-39 was submerged in a bath consisting of a molten mixture of 25 g of catechol, 10 mLs of water and 1-2 mLs of acetic acid, for about 10 minutes at 160-180 degrees F., removed, and cooled for a few seconds in an air stream, and washed twice in distilled water
Step 4. The above piece of CR-39 was next submerged in a bath consisting of 5% sodium hypochlorite in water (bleach) to which was added tetrabutylammonium chloride and copper sulfate. The concentrations were 0.003-0.3 M tetrabutylammonium chloride and 0.001 M CuSO4. The CR-39 was treated with this bath for about 2 hours at room temperature, removed anti washed twice in distilled water, and dried.

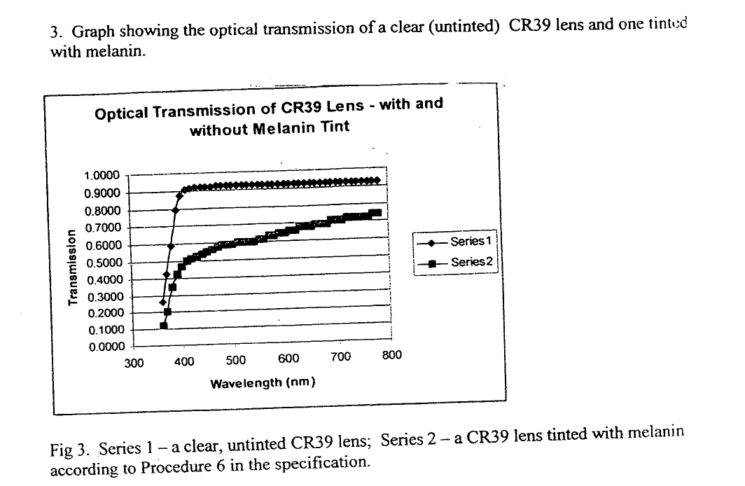

A transmission spectrum for the article treated according to Procedure 6 is shown in FIG. 3.

Second Embodiment. As an alternate to functionalizing the surface of the plastic to be tinted, it is possible to cause the melanin to leave the aqueous phase by lowering its pH. Observed visibly as aggregation, such acidified melanin is better able to enter the solid plastic matrix because it is no longer solvated and held by the water. While the invention has been described herein with reference to certain specific materials, procedures and examples, it is understood that the invention should not be restricted to these items used here mainly for the purpose of illustrations. Numerous variations of such details can be employed by those skilled in the art within the scope of this invention which is defined by the appended claims.

1. A method for tinting the surface of a solid substrate such as a plastic sheet, or a coating, or a film, with a nanometer-sized, or a multi-nanometer-sized polyphenol, such as melanin, in which said solid substrate is:
a) chemically etched to cause multi-nanometer-sized pores within a thin, several microns layer of the substrate but sufficiently small pore sizes to preclude visible light scatter;
b) functionalized so as to react and bond with the said polyphenol, or melanin

2. A method for tinting the surface of a solid substrate, according to claim 1, in which the substrate is CR39.

3. A method for tinting the surface of a solid substrate, according to claim 1, in which the substrate is a polymer hard coating

4. A method for tinting the surface of a solid substrate, according to claim 1, in which the etching agent is sodium hydroxide.

5. A method for tinting the surface of a solid substrate, according to claim 1, in which the etching agent is accompanied by a phase transfer catalyst, such as
tetrabuytlammonium bromide or by the addition of hexanediamine or by the addition of domiphen bromide.
